(19) United States
(12) Patent Application Publication
(10) Pub. No.: US 2018/0257915 A1
(43) Pub. Date: Sep. 13, 2018

(54) HYDRAULIC CONTROLLER FOR A HYDRAULICALLY ACTUATED LIFTABLE AND LOWERABLE HOOK OF A CRANE

(71) Applicant: XCMG EUROPEAN RESEARCH CENTER GMBH, Krefeld (DE)

(72) Inventors: Torsten VERKOYEN, Brueggen (DE); Heinz Henning HOPPMANN, Krefeld (DE); Christian STAMMEN, Korschenbroich (DE)

(21) Appl. No.: 15/754,421

(22) PCT Filed: Aug. 16, 2016
(86) PCT No.: PCT/EP2016/069399

§ 371 Date: Feb. 22, 2018

(30) Foreign Application Priority Data
Aug. 25, 2015 (EP) 15182321.8

(51) Int. Cl. B66C 13/20; B66D 1/08; B66D 5/26; B66D 1/44; B66C 23/00; F15B 11/044

(52) U.S. Cl. CPC B66C 13/20; B66D 1/08; B66D 5/26; B66D 2700/0133; B66C 23/54; F15B 11/044; B66C 2700/0357; B66D 1/44

(57) ABSTRACT

A hydraulically actuated liftable and lowerable hook of a crane has a hydraulic system comprises at least one working machine with a hydraulic motor driving a winch. At least one drive machine comprising a pump is connected directly or indirectly to at least one of the working machines by means of two connections via corresponding working lines, which serve as a feed or return depending on the operating state of the working machine. A lowering brake valve is provided in one working line and is connected to the other working line via a control line such that the lowering brake valve is displaceable against a restoring force by pressure, which prevails in the other working line and is forwarded via the control line, from the blocking position of said valve into a through-flow position for lowering the hook by means of a primary winch.

The invention relates to a hydraulic controller for a hydraulically actuated liftable and lowerable hook of a crane, wherein the hydraulic system comprises at least one working machine, which is designed as a hydraulic motor and drives the winch, and at least one drive machine, which is designed, in particular, as a pump, wherein the working machine is connected directly or indirectly to at least one of the drive machines by means of two connections via corresponding working lines, which connections serve as a feed or return depending of the operating state of the working machine, and wherein a lowering brake valve is provided in one working line and is connected to the other working line via a control line in such a way that the lowering brake valve is displaceable against a restoring force by the pressure, which prevails in the other working line and is forwarded via the control line, from the blocking position of said valve into a through-flow position for lowering the hook by means of the winch, in particular a primary winch.

Such hydraulic controllers in which a hydraulic resistor in the control line and a hydraulic resistor in the outflow line determine the opening pressure of the lowering brake valve are known from practice. A disadvantage here is that a targeted control of the lowering is thus not possible. Either the lowering takes place securely, but slowly, or there is the risk of vibrations and/or cavitation in the case of excessively large lowering, depending on the design of the hydraulic resistors.

It is an object of the invention to avoid the aforementioned disadvantages and to specify a hydraulic controller by means of which the risk of unstable states is reduced or even avoided.

This object is achieved in that an outflow line leading back to a tank branches off from the control line, wherein, for an adjustment of the control pressure acting on the lowering brake valve to different values, the outflow line is provided with a switching possibility, by means of which the effective hydraulic resistance in the outflow line can be changed to at least two different values by open-loop or closed-loop control.

Examples of hydraulic resistors which come into consideration are orifice plates, throttles or mixed forms.

For an adjustment of the control pressure acting on the lowering brake valve to different values, the control line can be provided with a switch between internal and external control. Here, the signal of the external control can be limited in such a way that complete opening of the lowering brake valve is not possible.

A fraction of the pressure is channeled away through the outflow line leading back to the tank, with the result that the pressure acting on the lowering brake valve is reduced by this fraction. If the two parallel hydraulic resistors, in particular orifice plates, are operated simultaneously in the outflow line leading back to the tank, a greater feed-through results, with the result that the pressure acting on the lowering brake valve is reduced and the lowering proceeds more slowly.

With the external control activated, the pressure feedback in the drive machine/pump remains constant and the latter continues in its basic state, which can be, for example, about 30 bar. In this respect, a switch between secured fine control and standard switching can be achieved. A fine control is thus also possible if no block and tackle is present and thus the lowering travel is proportional to the rotational speed of the working machine.

The working line which serves as a feed during the prevailing operating state of the working machine can preferably be loaded with a volumetric flow which controls the working speed and which can be changed at least in certain operating states via a gas pedal and/or a joystick. Furthermore, a control line can connect the working line which serves as a return during the prevailing operating state of the working machine to the switching possibility for loading the loading the switching possibility by the back pressure which, on account of the line resistance, results in the working line which serves as a return during the prevailing operating state of the working machine.

Alternatively, a different open-loop or closed-loop control is also possible, such as, for example, an active, for example electric, control. Here, the switching possibility can also be actuated in dependence on the valve path of the lowering brake valve. The coupling can be arbitrary, for example mechanical, hydraulic or in some other form.

The switching possibility can also be configured as a combined component and comprise a switchable hydraulic resistor, in particular an orifice plate.

According to the invention, the value of the smaller hydraulic resistance can be 0.66 times or 0.85 times the value of the larger hydraulic resistance or the diameter of the smaller orifice plate can be about 0.66 times or 0.85 times the diameter of the larger orifice plate. As a departure, however, all ratio values from 0 to 1 are possible.

Furthermore, for the switch between internal and external control of the control pressure acting on the lowering brake valve through the control line, there can be provided two hydraulic resistors, preferably orifice plates of different diameter, which are provided in parallel to one another, of which the larger hydraulic resistor or the orifice plate with the smaller diameter can be switched via a switching possibility between an activated state and a deactivated state, wherein these two hydraulic resistors or orifice plates open into the control line via a change-over valve. A finer control is possible as a result.

For the switch between internal and external control of the control pressure acting on the lowering brake valve through the control line, there can also be provided a change-over between two orifice plates of different diameter which are connected to a 3/2 way valve and are provided in parallel to one another.

Here, it is possible in each case for the value of the smaller hydraulic resistance to be 0.6 times the value of the larger hydraulic resistance diameter or for the diameter of the smaller orifice plate to be 0.6 times the diameter of the larger orifice plate. As a departure, however, all ratio values from 0 to 1 are possible.

In addition, a nonreturn valve can further be provided in the line section with the smaller hydraulic resistance, in particular with the larger orifice plate, through which nonreturn valve flow can pass only in the direction from the smaller hydraulic resistance, in particular the larger orifice plate, to the 3/2-way valve.

The external control can preferably be assigned a dedicated pump from which it is supplied. The external control can also be connected to the drive machine designed as a pump.

Exemplary embodiments of the invention which are illustrated in the drawings are explained hereinbelow. In the drawings:

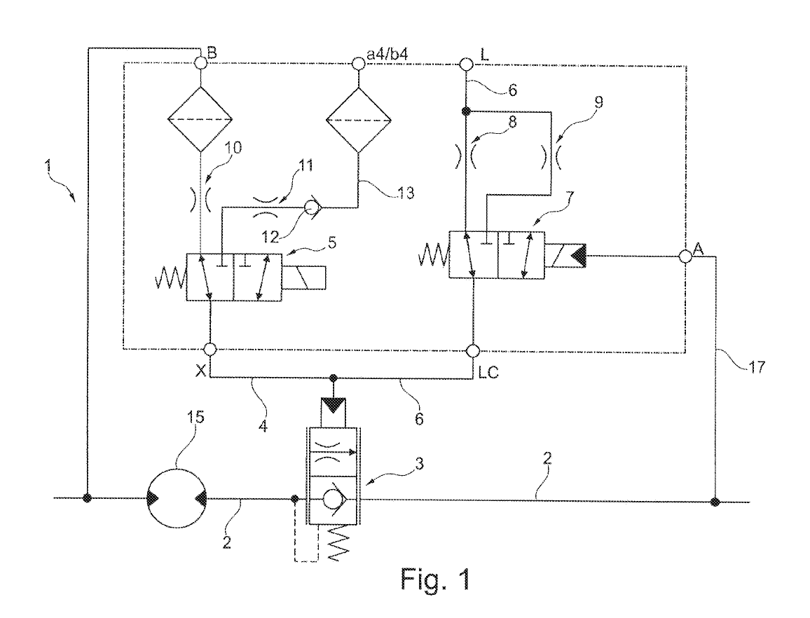

FIG. 1 shows a first exemplary embodiment of a hydraulic controller according to the invention,

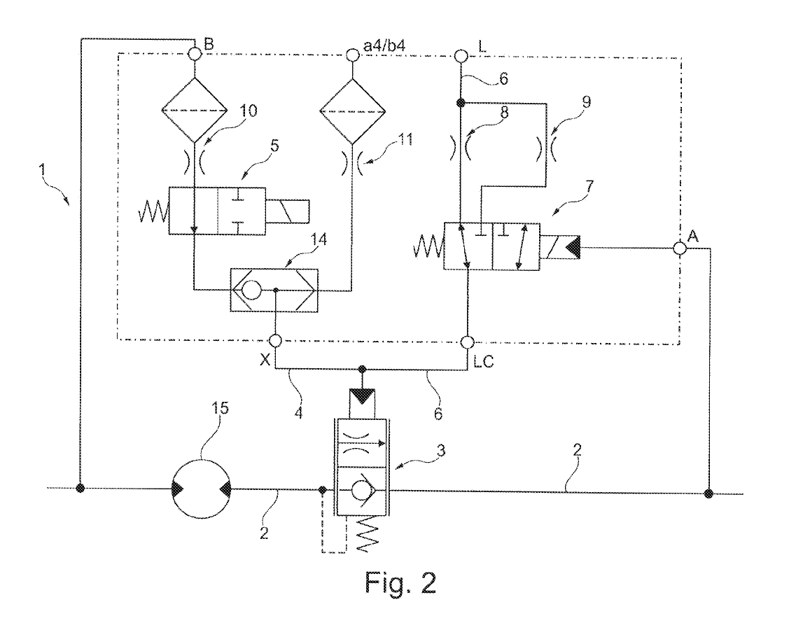

FIG. 2 shows a second exemplary embodiment of a hydraulic controller according to the invention,

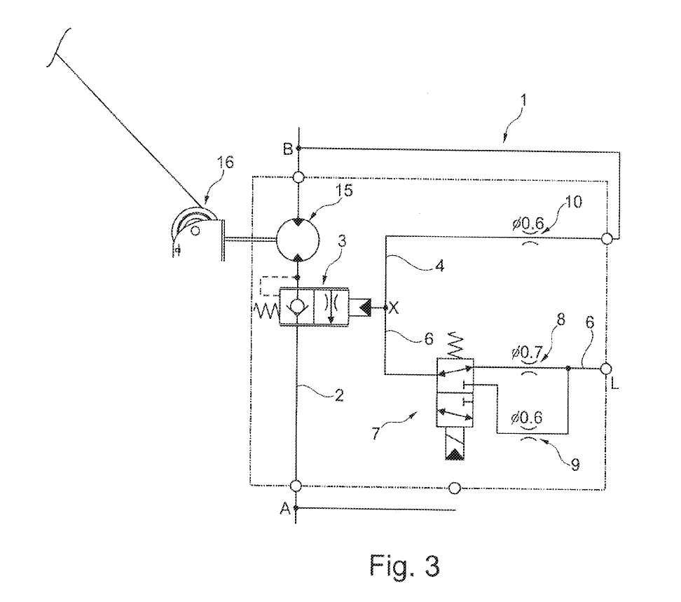

FIG. 3 shows a third exemplary embodiment of a hydraulic controller according to the invention,

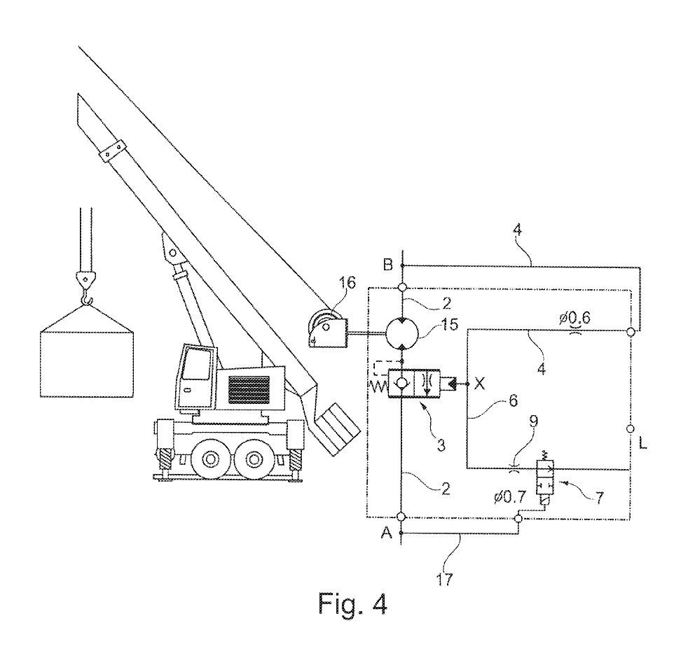

FIG. 4 shows a fourth exemplary embodiment of a hydraulic controller according to the invention,

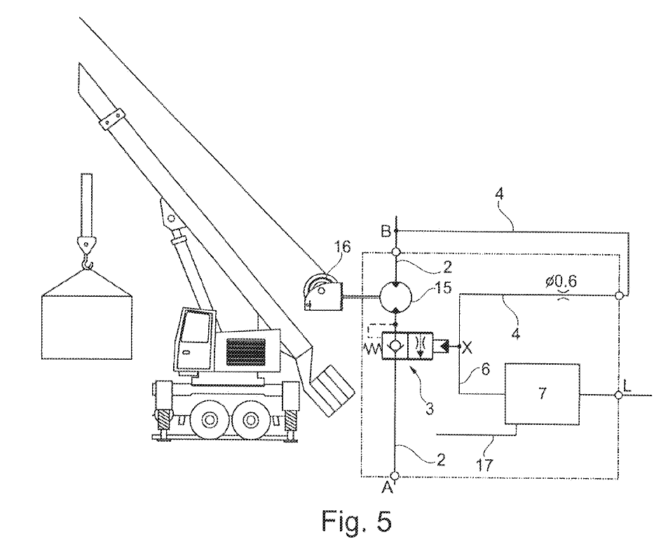

FIG. 5 shows a fifth exemplary embodiment of a hydraulic controller according to the invention,

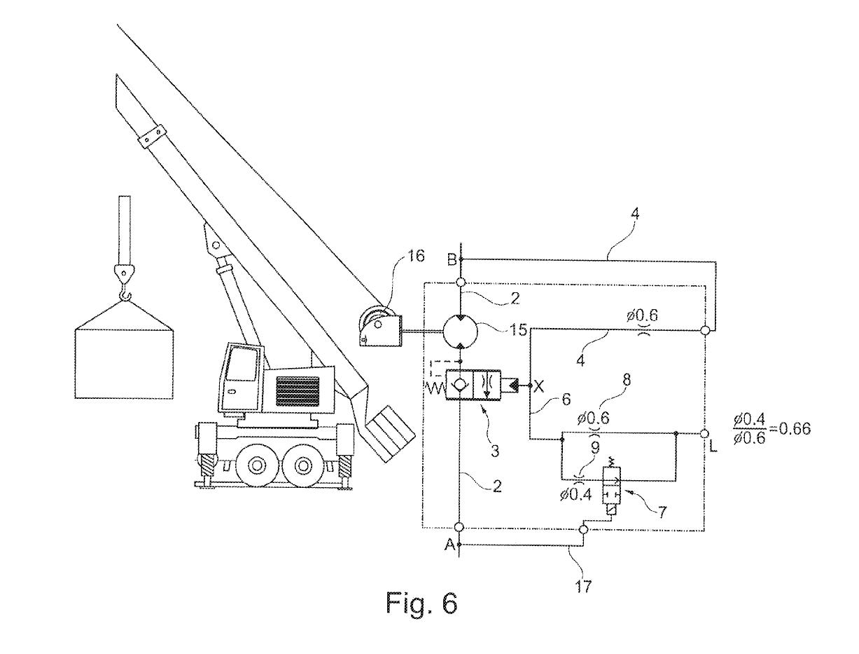

FIG. 6 shows a sixth exemplary embodiment of a hydraulic controller according to the invention, and

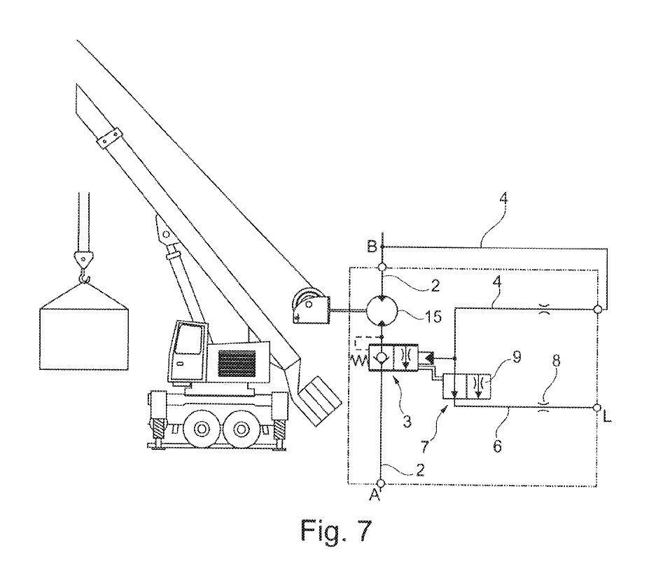

FIG. 7 shows a seventh exemplary embodiment of a hydraulic controller according to the invention.

Corresponding reference signs are used for like or identical components in all the figures.

FIG. 1 shows a hydraulic controller 1 for a hydraulically activated hook (not illustrated in the drawing) which belongs to a crane and can be lifted and lowered by means of a winch. Here, the hydraulic system (not illustrated in more detail in this respect) has at least one working machine 15, which is designed as a hydraulic motor and drives the winch 16 of the crane, and at least one drive machine, which is designed as a pump. The working machine 15 is connected directly or indirectly to at least one of the drive machines by means of two connections via corresponding working lines 2, which connections serve as a feed or return depending on the operating state of the working machine 15.

In the working line 2, which serves as a return during lowering, there is provided—as illustrated in FIG. 1—a lowering brake valve 3 which is connected to the other work line 2 via a control line 4 in such a way that the lowering brake valve 3 is displaceable against a restoring force by the control pressure, which prevails in this other working line 2 and is forwarded via the control line 4, from the blocking position of said valve into a through-flow position for lowering the hook by means of the winch 16, in particular a primary winch.

For an adjustment of the control pressure acting on the lowering brake valve 3 to different values, the control line 4 is provided with a switch 5 for switching between internal and external control. For this purpose, an outflow line 6 leading back to the tank (not illustrated in the drawing) branches off from the control line 4 between the switch 5 and the lowering brake valve 3, in which outflow line there is provided a further switching possibility 7 pertaining to two orifice plates 8, 9 of different diameters that are provided in parallel to one another.

Here, it is possible to switch between the orifice plate 8 and the orifice plate 9 via the switching possibility 7, which is formed by a 3/2-way valve, wherein quicker lowering occurs with the smaller orifice plate 9 and more stable operation with slower lowering occurs with the larger orifice plate 8 and wherein, furthermore, the signal of the external control is limited in such a way that complete opening of the lowering brake valve 3 is not possible. Here, the diameter of the smaller orifice plate 9 is about 0.66 times the diameter of the larger orifice plate 8.

A fraction of the pressure is channeled away through the outflow line 6 leading back to the tank, with the result that the pressure acting on the lowering brake valve 3 is reduced by this fraction. If the larger orifice plate 8 is operated in the outflow line 6 leading back to the tank, a greater feed-through results, with the result that the control pressure acting on the lowering brake valve 3 is reduced and lowering takes place more slowly.

The switch 5 for switching between internal and external control is formed by a 3/2-way valve. A nonreturn valve 12 is further provided in a line section 13 with the larger orifice plate 11, through which nonreturn valve flow can pass only in the direction from the larger orifice plate 11 to the 3/2-way valve.

A control line 17 connects the working line 2 which serves as a return during the prevailing operating state of the working machine 15 to the switching possibility 7 for loading the switching possibility 7 by the back pressure which, on account of the line resistance, results in the working line 2 which serves as a return during the prevailing operating state of the working machine 15.

In the further exemplary embodiment illustrated in FIG. 2, the switch between internal and external control of the control pressure acting on the lowering brake valve 3 through the control line 4 is achieved in a different way via two orifice plates 10, 11 of different diameter which are provided in parallel to one another, wherein these two orifice plates 10, 11 open into the control line 4 via a change-over valve 14 which switches in dependence on the prevailing pressures between the orifice plate 10 and the orifice plate 11. Here, the diameter of the smaller orifice plate 10 is 0.6 times the diameter of the larger orifice plate 11.

The change-over valve 14 is “actuated” by the switch 5 and the pressure which acts depending on the switching state of the switch 5.

The third exemplary embodiment shown in FIG. 3 shows a simplified version of the subject matter according to FIG. 1, wherein the switch between internal and external control that is shown in FIG. 1 is dispensed with and, instead, merely a fixed orifice plate 10 is provided. In addition, a drive machine 15 and a winch 16 actuated thereby are shown.

The fourth exemplary embodiment shown in FIG. 4 shows an alternative design, wherein the switching possibility 7 provided in the outflow line 6 is designed as a 2/2-way valve by means of which an orifice plate 9 can be activated or deactivated, with the result that the pressure acting on the lowering brake valve 3 can be changed.

In the variant shown in FIG. 5, the switching possibility 7 is designed as a “black box”, wherein the control line 17 is only indicated and can be loaded arbitrarily, for example electrically, hydraulically, pneumatically or in some other way. The control of the loading can also occur in an arbitrary manner.

The variant shown in FIG. 6 is similar to the design of the exemplary embodiment shown in FIG. 4, wherein the switching possibility 7 pertains to two orifice plates 8, 9 of different diameters that are provided in parallel to one another. Here, the orifice plate 9, which has the smaller diameter, can be switched between an activated state and deactivated state via the switching possibility 7 which is formed by a 2/2-way valve, wherein quicker lowering occurs with the larger orifice plate 8 (and deactivated smaller orifice plate 9) and more stable operation with slower lowering occurs in the activated state of the smaller orifice plate 9.

FIG. 7 shows a modification of the subject matter according to FIG. 6, it being the case here that the switching possibility 7 is configured as a combined component and comprises a switchable hydraulic resistor in the form of the orifice plate 9. Here, the switching possibility 7 is coupled mechanically to the valve path of the lowering brake valve 3. However, the coupling can also be realized, for example, hydraulically or in any other way. As long as the switching possibility 7 is set to “open”, the larger orifice plate 8 acts. However, as soon as the smaller orifice plate 9 is connected in series with the larger orifice plate 8 by the switching possibility 7, only the smaller orifice plate 9 acts since it has the greater hydraulic resistance.

1. A hydraulic controller (1) of a hydraulic system for a hydraulically actuated liftable and lowerable hook of a crane, wherein the hydraulic system comprises at least one working machine (15), which is designed as a hydraulic motor, and at least one drive machine, which is designed, in particular, as a pump, wherein the working machine (15) is connected directly or indirectly to at least one of the drive machines by means of two connections via corresponding working lines (2), which connections serve as a feed or return depending on the operating state of the working machine (15), and wherein a lowering brake valve (3) is provided in one working line (2) and is connected to the other working line (2) via a control line (4) in such a way that the lowering brake valve (3) is displaceable against a restoring force by the control pressure, which is present in this other working line (2) and forwarded via the control line (4), from the blocking position of said valve into a through-flow position for lowering the hook by means of a winch (16), preferably a primary winch, wherein an outflow line (6) leading back to a tank branches off from the control line (4), wherein, for an adjustment of the control pressure acting on the lowering brake valve (3) to different values, the outflow line (6) is provided with a switching possibility (7), by means of which the effective hydraulic resistance in the outflow line (6) can be changed to at least two different values by open-loop or closed-loop control.

2. The hydraulic controller (1) as claimed in claim 1, wherein the working line (2) which serves as a feed during the prevailing operating state of the working machine (15) is loaded with a volumetric flow which controls the working speed and which can be changed at least in certain operating states via a gas pedal.

3. The hydraulic controller (1) as claimed in claim 1, wherein the working line (2) which serves as a feed during the prevailing operating state of the working machine (15) is loaded with a volumetric flow which controls the working speed and which can be changed at least in certain operating states via a joystick.

4. The hydraulic controller (1) as claimed in claim 1, wherein there are provided two hydraulic resistors, preferably orifice plates (8, 9) of different diameters, which are provided, in particular in parallel to one another, in the outflow line (6), wherein one hydraulic resistor is always active and the other hydraulic resistor is assigned a further switching possibility (7), by means of which it is possible to switch between an activated state and deactivated state of the other hydraulic resistor, in particular for a switch between “stable operation” and slower lowering in the activated state of the other hydraulic resistor and “quicker lowering” in the deactivated state of the other hydraulic resistor.

5. The hydraulic controller (1) as claimed in claim 4, wherein the switching possibility (7) is configured as a combined component and comprises a switchable hydraulic resistor, in particular an orifice plate (9).

6. The hydraulic controller (1) as claimed in claim 4, wherein the switching possibility (7) is coupled to the valve path of the lowering brake valve (3).

7. The hydraulic controller (1) as claimed in claim 1, wherein a control line (17) connects the working line (2) which serves as a return during the prevailing operating state of the working machine (15) to the switching possibility (7) for loading the switching possibility (7) by the back pressure which, on account of the line resistance, results in the working line (2) which serves as a return during the prevailing operating state of the working machine (15).

8. The hydraulic controller (1) as claimed in claim 1, wherein the value of the smaller hydraulic resistance is 0.66 times or 0.85 times the value of the larger hydraulic resistance or the diameter of the smaller orifice plate (9) is 0.66 times or 0.85 times the diameter of the larger orifice plate (8).

9. The hydraulic controller (1) as claimed in claim 1, wherein, for the switch between the internal and external control of the control pressure acting on the lowering brake valve (3) through the control line (4), there are provided two hydraulic resistors, preferably orifice plates (10, 11) of different diameter, which are provided in parallel to one another, of which the larger hydraulic resistor or the orifice plate (10) with the smaller diameter can be switched between an activated state and deactivated state via a switching possibility (5), wherein these two hydraulic resistors or orifice plates (10, 11) open into the control line (4) via a change-over valve.

10. The hydraulic controller (1) as claimed in claim 1, wherein for the switch between internal and external control of the control pressure acting on the lowering brake valve (3) through the control line (4), there is provided a change-over between two hydraulic resistors or orifice plates (10, 11) of different diameter which are arranged on a 3/2-way valve and provided in parallel to one another.

11. The hydraulic controller (1) as claimed in claim 9, wherein the value of the smaller hydraulic resistance is 0.6 times the value of the larger hydraulic resistance or the diameter of the smaller orifice plate (10) is 0.6 times the diameter of the larger orifice plate (11).

12. The hydraulic controller (1) as claimed in claim 9, wherein there is further provided a nonreturn valve (12) in the line portion (13) with the smaller hydraulic resistance, in particular with the larger orifice plate (11), through which nonreturn valve flow can pass only in the direction from the smaller hydraulic resistance, in particular the larger orifice plate (11), to the 3/2-way valve.

13. The hydraulic controller (1) as claimed in claim 1, wherein the external control is assigned a dedicated pump from which it is supplied.

14. The hydraulic controller (1) as claimed in claim 1, wherein the external control is connected to the drive machine designed as a pump.

15. The hydraulic controller (1) as claimed in claim 2, wherein there are provided two hydraulic resistors, preferably orifice plates (8, 9) of different diameters, which are provided, in particular in parallel to one another, in the outflow line (6), wherein one hydraulic resistor is always active and the other hydraulic resistor is assigned a further switching possibility (7), by means of which it is possible to switch between an activated state and deactivated state of the other hydraulic resistor, in particular for a switch between “stable operation” and slower lowering in the activated state of the other hydraulic resistor and “quicker lowering” in the deactivated state of the other hydraulic resistor.

16. The hydraulic controller (1) as claimed in claim 3, wherein there are provided two hydraulic resistors, preferably orifice plates (8, 9) of different diameters, which are provided, in particular in parallel to one another, in the outflow line (6), wherein one hydraulic resistor is always active and the other hydraulic resistor is assigned a further switching possibility (7), by means of which it is possible to switch between an activated state and deactivated state of the other hydraulic resistor, in particular for a switch between “stable operation” and slower lowering in the activated state of the other hydraulic resistor and “quicker lowering” in the deactivated state of the other hydraulic resistor.

17. The hydraulic controller (1) as claimed in claim 5, wherein the switching possibility (7) is coupled to the valve path of the lowering brake valve (3).
